(19) United States
(12) Patent Application Publication
(10) Pub. No.: US 2009/0314501 A1
(43) Pub. Date: Dec. 24, 2009

(54) Frost-Proof Container for Extinguishing Fluid

(75) Inventors: Dirk Sprakel, Koln (DE); Max Lakkonen, Rosrath (DE)

Correspondence Address: Sunstein Kann Murphy & Timbers LLP, 125 SUMMER STREET, BOSTON, MA, 02110-1618, US

(73) Assignee: FOGTEC BRANDSCHUTZ GMBH & CO. KG, Köln (DE)

(21) Appl. No.: 12/305,335

(22) PCT Filed: Oct. 30, 2006
(86) PCT No.: PCT/EP2006/067929

§ 371 Date: Feb. 10, 2009

(51) Int. Cl. A62C 37/00

(52) U.S. Cl. 169/19

(57) ABSTRACT

Closure device 2 for pressure cylinders 6 storing extinguishing fluid 4, with a pressure cylinder 6 and an adapter piece 8 for the connection of an immersion pipe 10 arranged in the pressure cylinder 6, with a connection piece 12 arranged outside the pressure cylinder 6. In order to guarantee operation of a fire extinguishing device secure against frost, it is proposed that the immersion pipe 10 and the connection piece 12 are formed in such a way that the connection piece 12 in an idle state is partially filled with extinguishing fluid 4, the connection piece 12 comprises a riser pipe 14, in such a way that the riser pipe 14 lies at least partially above the level 16 of the extinguishing fluid 4, and that the riser pipe 14 comprises a bursting disc 18, in such a way that a gas space 20 is formed between the bursting disc 18 and the extinguishing fluid 4.

The invention relates to a closure device for pressure cylinders storing extinguishing fluid, with a pressure cylinder and an adapter piece for the connection of an immersion pipe arranged in the pressure cylinder, with a connection piece arranged outside the pressure cylinder.

Closure devices for pressure cylinders storing extinguishing fluid are known, for example, from EP 0 138 195 A2. This device relates to a self-actuating extinguisher unit for equipment subject to the risk of fire. A small pressure cylinder is mounted on an item of equipment and the extinguishing fluid is applied to the appropriate location by way of a blast pipe. In order to prevent the evaporation of the extinguishing fluid, the blast pipe is closed at its end by a material which, if a particular temperature is exceeded, will dissolve or liquefy. This leads to self-actuation. In the idle state the blast pipe is filled with extinguishing fluid. The extinguishing fluid is present directly at the outlet. If the extinguishing fluid expands, this may result in the destruction of the end piece of the blast pipe and extinguishing fluid could unintentionally emerge.

From EP 0 650 743 B1 a fire-extinguishing device is known for rail vehicles with a stationary container for extinguishing fluid. Because rail vehicles are constantly subjected to the surrounding temperature during operation, sharp temperature fluctuations may occur in the interior of the vehicle. In particular when rail vehicles are left standing in sidings, and are not heated, extremely low temperatures may prevail in their interiors. If the extinguishing fluid freezes in the pressure cylinders due to the extremely low temperatures, the expanding extinguishing fluid can cause damage to the pipes as well as to the closure valves.

In order to prevent damage to the pipes and valves, EP 0 650 743 B1 proposes that pipes and valves be manufactured from materials with good material properties. By the use of thermoelastic plastic, material damage caused by expansion stresses, such as brittleness or crack formation, is avoided.

The disadvantages with the use of thermoelastic plastic lie on the one hand in the high procurement costs and, on the other, in the deficient fire resistance of these materials. In the event of a fire it may happen that the pipes melt due to the enormous heat of the fire, and satisfactory fire-fighting is no longer possible.

In order to guarantee a high degree of security against frost for the fire extinguishing device, in conjunction with high operational reliability and low procurement costs, the invention proposes that the immersion pipe and the connection piece are formed in such a way that the connection piece in an idle state is partially filled with extinguishing fluid, that the connection piece comprises a riser pipe in such a way that the riser pipe lies at least partially above the level of the extinguishing fluid, and that the riser pipe comprises closure means in such a way that a gas space is formed between the closure means and the extinguishing fluid.

The closure means can be formed as a bursting disc or as a valve. If a valve is used, it can be actuated by a fire alarm system and open in the event of a fire. This can be effected electrically or mechanically. By the imposition of pressure, which is likewise controlled by a fire alarm system, compressed air or gas can be driven into the pressure cylinder and the extinguishing fluid driven out. In the case of a bursting disc as the closure means, it is possible for this to be caused to burst by the imposition of pressure, as a result of which extinguishing fluid can likewise escape.

With mobile applications in particular, for heavy goods vehicles or buses for example, protection against frost cannot always be guaranteed by heating. For example, if vehicles are left standing for extended periods it is not possible for sustained heating to be provided by the battery, since this would lead to the battery being drained. The additional heating would have to be switched off with long standstill periods. This could cause the extinguishing fluid to freeze and lead to the destruction of conventional closure means. By means of the solution according to the invention, the destruction of the closure means will be avoided.

The closure device according to the invention is particularly suitable for pressurized cylinders which are lying flat. In this case, a horizontally arranged immersion pipe is immersed in the pressurized cylinder into the extinguishing fluid. Arranged at the outlet of the immersion pipe is a connection piece with a riser pipe which extends vertically. The riser pipe is shaped in such a way that it lies at least partially above the level of the extinguishing fluid.

The closure means are arranged in the riser pipe or at its end. The closure means are, according to the invention, arranged above the level of the extinguishing fluid. A gas space forms between the level of the extinguishing fluid and the closure means. If the extinguishing fluid freezes, this will initially happen at the peripheral expansion areas of the pressurized cylinder and the connection pieces, i.e. at the inner wall of the pressure cylinder, as well as at the adaptor piece, in particular at the immersion pipe, connection piece, and riser pipe. The riser pipe will regularly be the first to freeze, since it is subjected unprotected to the outside temperature. If the extinguishing fluid thereafter freezes in the interior of the pressure cylinder and the immersion pipe, it must expand. The expansion leads to the ice plug formed in the riser pipe being pressed in the direction of the closure means. The gas space between the closure means and the level of the extinguishing fluid allows for the expansion and displacement of the ice plug in the riser pipe, without the closure means being damaged. If the closure means were to be located directly at or below the level of the extinguishing fluid, they would be damaged by the expansion of the fluid and the displacement of the ice plug associated with this. When thawing out, the extinguishing fluid could emerge from the pressurized cylinder unimpeded.

Due to the design of the riser pipe and the connection pipe according to Claim 1, such destruction of the closure means is avoided. The closure device is well-suited for protecting a dry system, in which the pipes leading to the extinguishing fog nozzles are filled with air in the idle state and in which the extinguishing fluid is not introduced into the pipes until a fire occurs. It would also be possible for wet systems to be protected with the solution according to the invention. For example, a salt solution could be kept in reserve in the pipes, which has a lower freezing point.

It would also be possible for the riser pipe to be designed in a U-shape. If the U is arranged in such a way that the delivery line and the outlet line lie beneath the curve, a gas space could form in the curve. The closure means could be arranged in this gas space.

In the event of a fire, compressed air is imposed on the interior of the pressure cylinder, using compressed air or gas. If a bursting disc is used as the closure means, this causes the extinguishing fluid to be pressed in the direction of the disc until the bursting pressure is reached. The bursting disc bursts and the extinguishing fluid is driven into the pipeline until it emerges from the extinguishing mist nozzles. With a valve as the closure means, this can be opened by a fire alarm system before the pressure imposition is activated.

It is preferred for the gas space to be designed in such a way that, in the event of the extinguishing fluid freezing in the connection piece, the frozen extinguishing fluid can expand in the direction of the closure means. With a bursting disc, the gas space can be dimensioned in such a way that, on the expansion of the fluid, the bursting pressure is not attained. The distance between the bursting disc and the level of the extinguishing fluid must be selected in such a way that a maximum frost-incurred expansion of the extinguishing fluid does not drive the gas pressure above the bursting pressure. Measurements have revealed that an expansion of up to 9% of the extinguishing fluid is possible in the event of freezing. This expansion must be accommodated by the gas space. By the use of the closure device according to the invention, it is possible for pressure cylinders to be filled to 90 to 95%, without any fear of destruction caused by frost.

With pressure cylinders lying horizontal in particular, complete emptying in the event of a fire must be guaranteed. For this reason it is proposed that the immersion pipe is inclined in the direction of the inner wall of the pressure cylinder.

The filling of the pressure cylinder is possible preferably up to a filling degree of 90 to 95%. In this case it is proposed that, with a pressure cylinder lying on one side, the immersion pipe and the connection piece lie beneath the level of the extinguishing fluid in such a way that the immersion pipe is filled completely with extinguishing fluid, and that the connection piece is filled with extinguishing fluid at least as far as the riser pipe. It is preferred that the riser pipe is at least partially filled with extinguishing fluid. It must only be guaranteed that the gas space between the closure means and the level of the extinguishing fluid is sufficiently big for the expansion of the extinguishing fluid caused by freezing to be compensated for.

By means of the use of the closure device according to the invention, fire extinguishing devices can also be operated if there is a fear that the extinguishing fluid may freeze from time to time due to frost. Preferably, the admixing of an anti-freeze agent to the extinguishing fluid is no longer necessary. In particular, according to an advantageous embodiment, water is suitable as the extinguishing fluid.

A further object of the invention is a system for fighting fire with an extinguishing fluid reservoir with a closure device according to Claim 1 and a pipe arranged at the connection piece, wherein the pipe comprises at least one open extinguishing nozzle for the delivery of extinguishing fluid, and wherein the closure means seal off the pipe from the immersion pipe. Such a system can be operated with the device according to the invention secure against frost. Destruction of the closure means due to expansion induced by frost will be avoided.

Preferably, extinguishing mist nozzles are used for the delivery of a finely distributed extinguishing mist.

The invention is described hereinafter in greater detail on the basis of a drawing showing an embodiment.

The drawings show:

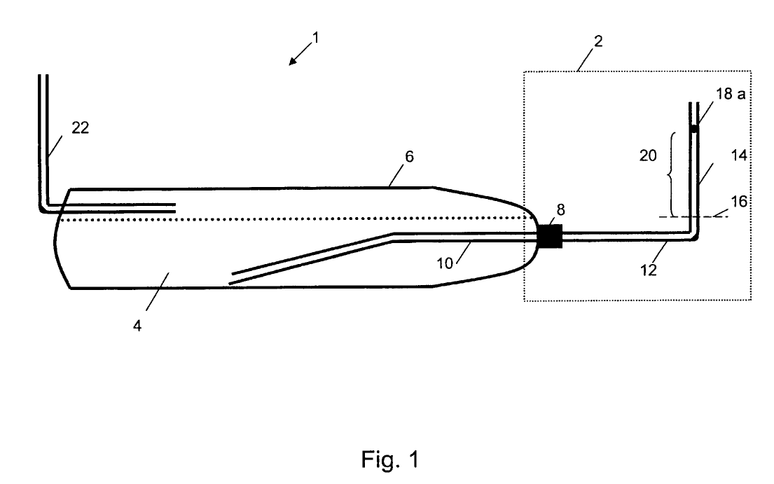

FIG. 1 A closure device according to a first embodiment;

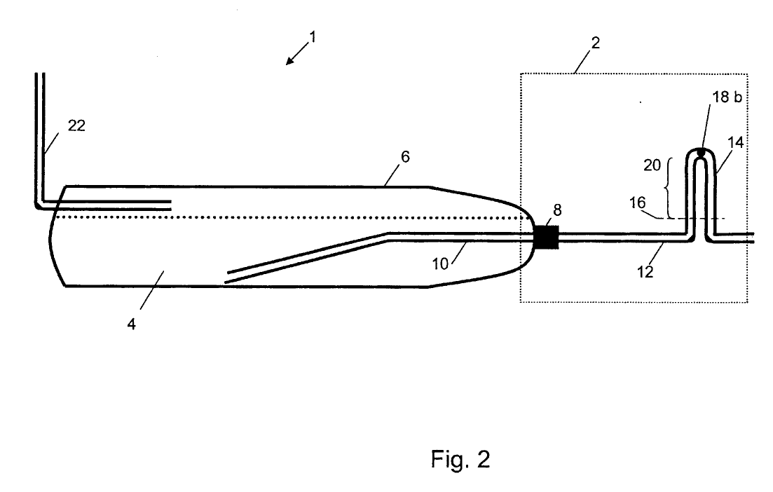

FIG. 2 A closure device according to a second embodiment.

FIG. 1 shows a fire extinguishing device 1 with a closure device 2 and a pressure cylinder 6. The closure device 2 is formed from an adapter piece 8, a connection piece 12, a riser pipe 14, and a bursting disc 18a. Provided in the pressure cylinder 6 is an immersion pipe 10, inclined in the direction of the inner wall of the pressure cylinder 6. The immersion pipe 10 is below the level of the extinguishing fluid 4. In the event of a fire, compressed air is introduced into the pressure cylinder 6 by means of a compressed air imposition system 22, which is provided with a non-return valve (not represented), and the extinguishing fluid is driven out of the pressure cylinder 6.

The closure device 2 is formed in such a way that from the connection piece 12 the riser pipe 14 branches into the vertical direction, preferably perpendicularly. The bursting disc 18a in the riser pipe 14 is arranged in such a way that it lies above the level 16 of the extinguishing fluid 4. A gas space 20 forms between the bursting disc 18a and the level 16 of the extinguishing fluid 4.

If extreme temperature fluctuations occur during operation of the fire extinguishing device 1, in particular very low temperatures, the extinguishing fluid 4 freezes in the pressure cylinder 6. The extinguishing fluid 4 freezes first in the area of the riser pipe 14 and the connection piece 12. Then the extinguishing fluid 4 freezes in the immersion pipe 10 and the pressure cylinder 6 and expands. The extinguishing fluid frozen in the riser pipe 14 is pressed by this expansion in the direction of the bursting disc 18a. Due to the displacement of the ice plug in the direction of the bursting disc 18a, the gas space 20 is compressed. The gas space 20 is dimensioned in such a way, however, that the frost-induced increase in the gas pressure always remains below the bursting pressure of the bursting disc 18a. Expansions of up to 10% of the extinguishing fluid are compensated for by the gas space 20.

In the event of a fire, compressed air is pressed into the pressure cylinder 6 via the compressed air imposition device 22. The extinguishing fluid is pressed via the immersion pipe 10, the connection piece 12 and the riser pipe 14 in the direction of the bursting disc 18a. The pressure is then above the bursting pressure of the bursting disc 18a and the bursting disc 18a bursts. The extinguishing fluid is conveyed through a pipe system (not shown) to extinguishing mist nozzles (not shown) and from there is conducted as a finely distributed mist to fight the fire.

FIG. 2 shows a further embodiment. In contrast to FIG. 1, in this case the riser pipe 14 is formed U-shaped. The inflow and outflow of the riser pipe 14 lie beneath the curve of the riser pipe 14. A valve 18b is arranged in the gas space 20. In the event of a fire this valve opens before the pressure cylinder 6 is subjected to compressed air or gas.

With the variant shown in FIG. 2 it is possible for fluid to be in the pipes on both sides of the riser pipe. A gas space 20 forms only above the level 16.

By means of the closure device according to the invention it is possible to guarantee frost-secure operation of fire extinguishing systems in an economical manner.

1-8. (canceled)

9. A closure device for pressure cylinders storing extinguishing fluid, comprising:
a pressure cylinder containing extinguishing fluid;
an immersion pipe arranged in the pressure cylinder;
a connection piece arranged outside the pressure cylinder, the connection piece including a riser pipe that includes a closure;
an adapter piece for connecting the immersion pipe with the connection piece;
wherein the immersion pipe and the connection piece are arranged in such a way that the connection piece in an idle state is partially filled with extinguishing fluid, with the riser pipe lying at least partially above the level of the extinguishing fluid in the pressure cylinder, and the closure arranged in such a way that a gas space is formed between the closure and the extinguishing fluid in the connection piece.

10. A closure device according to claim 9, wherein the gas space is formed in such a way that, in the event of the extinguishing fluid freezing in the connection piece, the frozen extinguishing fluid can expand in the direction of the closure.

11. A closure device according to claim 9, wherein the immersion pipe is inclined in the direction of the inner wall of the pressure cylinder.

12. A closure device according to claim 9, wherein the riser pipe is formed U-shaped, wherein the inflow and outflow are arranged below the curve, in such a way that the gas space forms in the curve, and in that the closure are arranged in the curve.

13. A closure device according to claim 9, with the pressure cylinder lying on its side, the immersion pipe and the connection piece lie below the level of the extinguishing fluid, in such a way that the immersion pipe is completely filled with extinguishing fluid, and in that the connection piece is filled with extinguishing fluid at least as far as the riser pipe.

14. A closure device according to claim 9, wherein the extinguishing fluid is free of frost protection means.

15. A closure device according to claim 9, wherein the extinguishing fluid is water.

16. A closure device according to claim 9, wherein the closure comprises a bursting disc.

17. A closure device according to claim 9, wherein the closure comprises a valve.

18. A system for fighting fires with an extinguishing fluid reservoir comprising a closure device of claim 9 and a pipe arranged at the connection piece, wherein the pipe comprises at least one open extinguishing nozzle for the delivery of extinguishing fluid, and wherein the closure seals off the pipe from the immersion pipe.
